(19) United States
(12) Patent Application Publication
(10) Pub. No.: US 2016/0295623 A1
(43) Pub. Date: Oct. 6, 2016

(54) Receiver Sharing Between D2D and Cellular Operations in Multi-Carrier System

(71) Applicant: TELEFONAKTIEBOLAGET LM ERICSSON (PUBL), Stockholm (SE)

(72) Inventors: Muhammad Kazmi, Bromma (SE); Iana Siomina, Täby (SE)

(21) Appl. No.: 14/778,504

(22) PCT Filed: Aug. 5, 2015
(86) PCT No.: PCT/SE2015/050848

§ 371 Date: Sep. 18, 2015

Related U.S. Application Data
(60) Provisional application No. 62/034,553, filed on Aug. 7, 2014.

(51) Int. Cl. H04W 76/02; H04W 72/04

(52) U.S. Cl. CPC H04W 76/023; H04W 72/0453; H04W 88/06

(57) ABSTRACT

There is discussed a D2D enabled node (10) for a wireless communication network, the D2D enabled node (10) comprising a receiver, the D2D enabled node (10) being adapted to share, according to a condition, use of the receiver between D2D operation and cellular operation.

There are also discussed related devices and methods.

### TECHNICAL FIELD

The present disclosure pertains to use of a receiver of a D2D enabled node for a wireless communication network as well as related methods and devices, in particular in the context of more than one carrier being utilized by the receiver.

### BACKGROUND

If D2D enabled nodes or UEs are in proximity to each other, they may be able to use a “direct mode” (e.g., as in FIG. 1) or “locally-routed” (e.g., as in FIG. 2) path for data communication, unlike in the conventional cellular communication (FIG. 3). In device-to-device communication, the source and the target are wireless devices, e.g., D2D enabled nodes or UEs. Some of the potential advantages are off-loading of the cellular network, faster communication, increased awareness of surrounding wireless devices of interest (e.g., running the same application), higher-quality links due to a shorter distance, etc. Some appealing applications of D2D communications are video streaming, online gaming, media downloading, peer-to-peer (P2P), file sharing, etc.

A D2D enabled node or UE capable of receiving in more than one carrier frequencies, but operating D2D in one of the carrier frequencies, may become restricted in at least one of its cellular operation over the remaining carrier frequencies, in the carrier frequency shared with D2D, and its D2D operation. Also, receiver resources may be inefficiently used, in particular if the D2D enabled node participates in both D2D communication and cellular communication.

### SUMMARY

There is generally disclosed a D2D enabled node for a wireless communication network. The D2D enabled node comprises a receiver. The D2D enabled node is adapted to share, according to a condition, use of the receiver between D2D operation and cellular operation.

There is also disclosed a method for operating a D2D enabled node in a wireless communication network. The D2D enabled node comprises a receiver. The method comprises sharing, according to a condition, use of the receiver between D2D operation and cellular operation.

Moreover, there is disclosed a network node for a wireless communication network. The network node is adapted to instruct a D2D enabled node to share a receiver between D2D operation and cellular operation.

In addition, there is disclosed a method for operating a network node in a wireless communication network. The method comprises instructing a D2D enabled node to share a receiver between D2D operation and cellular operation.

There is also disclosed a computer program product comprising instructions executable by control circuitry, the instructions causing the control circuitry to carry out and/or control one of the methods disclosed herein when executed by the control circuitry.

Furthermore, a storage medium storing instructions executable by control circuitry is disclosed, the instructions causing the control circuitry to carry out and/or control one of the methods disclosed herein when executed by the control circuitry.

Accordingly, a D2D enabled device may use a receiver for operations in different communication modes, namely D2D operation and cellular operation, allowing more efficient use of the receiver resources, in particular depending on operation conditions.

### BRIEF DESCRIPTION OF THE DRAWINGS

For the purpose of illuminating the concepts and approaches discussed herein, without limiting the disclosure to the content of the figures, the associated figures show:

FIG. 1 a “Direct mode” data path in the EPS for communication between two D2D enabled nodes or UEs;

FIG. 2 a “Locally-routed” data path in the EPS for communication between two D2D enabled nodes or UEs when D2D enabled nodes or UEs are served by the same eNBs;

FIG. 3 a default data path scenario in the EPS for cellular communication between two D2D enabled nodes or UEs;

FIG. 4 an exemplary D2D architecture;

FIG. 5 an exemplary network node or base station;

FIG. 6 an exemplary D2D enabled node or UE;

FIGS. 7a-d examples of inter-frequency switching;

FIG. 8a a diagram for a method performed by a D2D enabled node;

FIG. 8b a diagram for a method performed by a network node;

FIG. 9a an example of a D2D enabled node; and

FIG. 9b an example of a network node.

### DETAILED DESCRIPTION

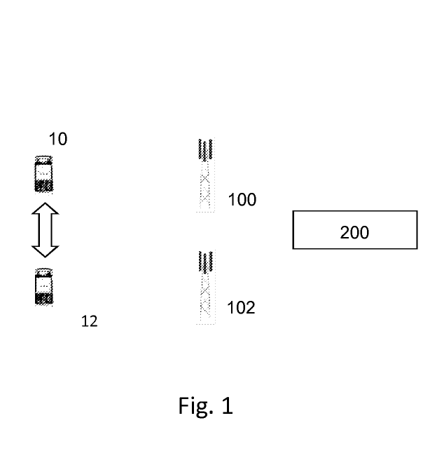

In FIGS. 1 to 3, there are shown different setups for communication of user equipments within a wireless communication network. In these figures, the first node or first user equipment UE1 is indicated with reference numeral 10, the second node or second user equipment is indicated with reference numeral 12.

A first base station, which may be an eNodeB and/or EPC according to LTE/E-UTRAN, carries the reference numeral 100, whereas a second base station, which may be an eNodeB and/or EPC according to LTE/UTRAN, is referenced with numeral 102. The nodes 100, 102 may be configured as coordinating nodes for D2D communication between the UEs 10, 12. Reference numeral 200 indicates higher layer functions or devices of the network, to which the base stations 100, 102 may be connected or connectable, e.g. LTE packet core elements like SGW (Server GateWay) and/or PGW (PDN GateWay) and/or MME (Mobility Management Entity).

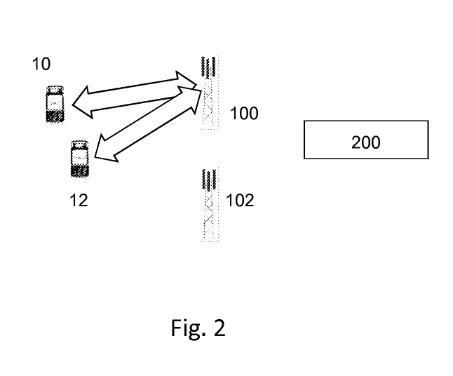

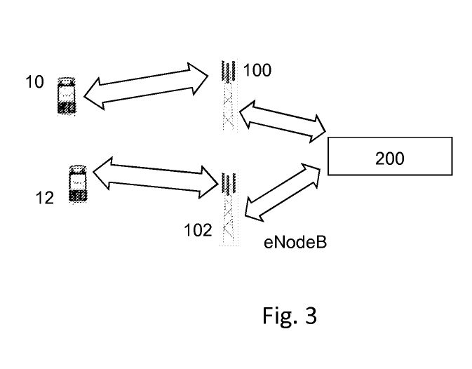

If UEs 100, 102 are in proximity to each other, they may be able to use a “direct mode” (e.g., as in FIG. 1) or a “locally-routed” (e.g., as in FIG. 2) path for data communication, unlike in the conventional cellular communication (FIG. 3).

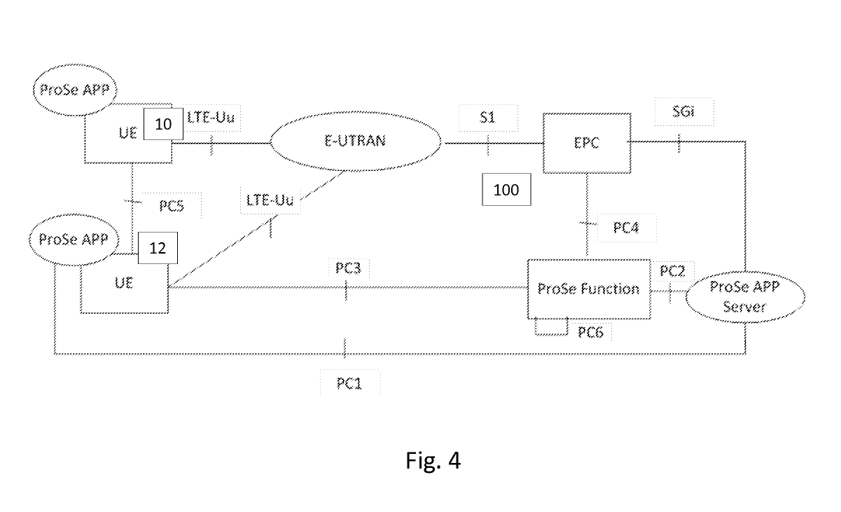

A more detailed example reference architecture for D2D operation according to one possible LTE/E-UTRAN implementation is illustrated in FIG. 4, in which only a setup with two UEs 10, 12 connected to a common base station or eNodeB 100 is shown. In FIG. 4, PCn identifies different reference points or interfaces. PC1 refers to a reference point between a

ProSe application ProSe APP running on an D2D enabled node or UE 10 or 12, PC2 a reference point between an ProSe Application server and a ProSe function provider on a server or base station side. PC3 indicates a reference point between the D2D enabled node or UE 12 and the ProSE function, e.g. for discovery and/or communication. PC4 refers to a reference point between the EPC and the ProSe function, e.g. for setting up setting up one-to-one communication between UEs 10 and 12. PC5 is a reference point between D2D enabled node or UE 10 and D2D enabled node or UE 12, e.g. a first node and a second node involved in D2D communication, which may be used e.g. for direct or relayed communication between the UEs. PC6 identifies a reference point between ProSE functions of different networks, e.g. if UEs 10, 12 are subscribed to different PLMNs (Public Land Mobile Networks). SGi indicates an interface which may be used, inter alia, for application data and/or application level control.

The EPC (Evolved Packet Core) may generally include a plurality of core packet functions or entities, e.g. MME, SGW, PWG, PCRF (Policy Charging and Rules Function), HSS (Home Subscriber Server), etc. E-UTRAN is the preferred RAT of the arrangement of FIG. 4. LTE-Uu indicates data transmission connections between the UEs 10, 12 and the base station 100.

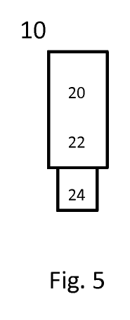

FIG. 5 schematically shows a D2D enabled node or user equipment 10, which may be a node of a device-to-device communication, in closer details. User equipment 10 comprises control circuitry 20, which may comprise a controller connected to a memory. A receiving module and/or transmission module and/or control module may be implemented in the control circuitry 20, in particular as module in the controller. The user equipment also comprises radio circuitry 22 providing receiving and transmitting or transceiving functionality, the radio circuitry 22 connected or connectable to the control circuitry. An antenna circuitry 24 of the user equipment 10 is connected or connectable to the radio circuitry 22 to collect or send and/or amplify signals. Radio circuitry 22 and the control circuitry 20 controlling it are configured for device-to-device communication, in particular utilizing E-UTRAN/LTE resources as described herein and/or receiving allocation data and/or transmit D2D data based on allocation data.

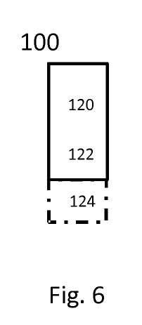

FIG. 6 schematically show a base station 100, which in particular may be an eNodeB. Base station 100 comprises control circuitry 120, which may comprise a controller connected to a memory. A configuring unit and/or a determination unit may be comprised in the control circuitry, the latter in particular if the base station is configured as a coordinating node. The control circuitry is connected to control radio circuitry 122 of the base station 100, which provides receiver and transmitter and/or transceiver functionality. It may be considered that control circuitry 120 comprises an extracting unit as described herein, in particular if the base station is configured to participate as a device in D2D communication. An antenna circuitry 124 may be connected or connectable to radio circuitry 122 to provide good signal reception or transmittance and/or amplification.

Generally, a D2D enabled node or UE may be seen as an example or representative of a D2D enabled node and, if not explicitly stated otherwise, the term “UE” may be replaced by “D2D enabled node” throughout this description. It may be envisioned that D2D is performed in proximity of an allocation or coordinating node, which may be adapted to provide control functions for cellular and/or D2D communication, even if it does not necessarily participate in the D2D communication itself.

In systems with multiple carrier frequencies, a D2D enabled node or D2D enabled node or UE may operate over two or more carrier frequencies in parallel or in a sequential order, e.g., when performing measurements, transmitting or receiving radio signals or channels. Simultaneous or parallel operation over two or more carrier frequencies generally may require a higher complexity in the D2D enabled node or D2D enabled node or UE and a more complex receiver structure than serial or sequential order of operation.

Inter-frequency operation generally refers to performing measurements (e.g., inter-frequency RSRP/RSRQ and RSTD) and/or receiving broadcast channels (e.g., system information reading on PBCH) on a carrier frequency which is different from the serving frequency(-ies). D2D enabled nodes or UEs with a single receiver or receiver chain normally require measurement gaps for inter-frequency operation; other D2D enabled nodes or UEs may be always or in certain conditions capable of inter-frequency operation without measurement gaps.

The difference of CA (carrier aggregation) to inter-frequency operation is that in carrier aggregation, the D2D enabled node or UE has a possibility of operating over multiple serving cells or on a serving cell(s) which are not the primary serving cell. In such multi-carrier or carrier aggregation cellular system, a carrier is generally termed as a component carrier (CC) or sometimes is also referred to in the context of a cell or serving cell. In principle, each CC may have multiple cells.

The term carrier aggregation (CA) is also called (e.g. interchangeably called) “multi-carrier system”, “multi-cell operation”, “multi-carrier operation”, “multi-carrier” transmission and/or reception. This means that CA may be used for transmission of signaling and data in the uplink and/or downlink directions. One of the CCs is the primary component carrier (PCC), which may also be referred to as simply primary carrier or anchor carrier and which may define or correspond to a primary cell (PCell). The remaining CCs are called secondary component carrier (SCC) or simply secondary carriers or even supplementary carriers and may define or correspond to one or more secondary cells or serving cells (SCell). Generally, the primary or anchor CC may carry the essential D2D enabled node or UE specific signaling and/or control data. A primary CC (aka PCC or PCell) may exists in both uplink and downlink directions in CA. In case there is single UL CC, the PCell may be on that CC. The network may assign different primary carriers to different D2D enabled nodes or UEs operating in the same sector or cell. Generally, the term cell may refer to a PCell or a SCell.

There is generally disclosed a D2D enabled node for a wireless communication network. The D2D enabled node may comprise a receiver. It may be considered that the D2D enabled node is adapted to share, according to a condition, use of the receiver between D2D operation and cellular operation. The D2D enabled node may comprise a sharing module for sharing use of the receiver. Accordingly, the same receiver may be used in different communication operations, D2D operation and cellular operating. Based on the implementation of the condition, a large variety of scenarios and situation may be covered, allowing efficient use of the receiver, in particular in the context of different carriers and/or CA and different modes of operation. The D2D enable node may comprise a D2D module for D2D operation and/or a cellular module for cellular operation.

In a variant, the D2D enabled node may be adapted to control the receiver such that D2D operation is performed with a first carrier and cellular operation is performed with a second carrier. This allows a clean separation or association of the functionality between D2D and cellular operations/modes. Also, adaptation to allocated resources for the different modes, which might have different carriers/frequencies, is possible.

Generally, the condition may be priority based and/or weight based and/or opportunistic based, e.g. as discussed in more detail below.

In particular, the D2D enabled node, and/or the sharing module, may be adapted to use the receiver for D2D operation during a time T0 in which a SCell is deactivated. During such deactivation time, the receiver otherwise may be unused. Accordingly, the receiver may be used more efficiently.

There is also disclosed a method for operating a D2D enabled node in a wireless communication network. The D2D enabled node may comprise a receiver. The method may comprise sharing, according to a condition, use of the receiver between D2D operation and cellular operation.

The method may comprise controlling the receiver such that D2D operation is performed with a first carrier and cellular operation is performed with a second carrier.

It may be considered that the condition is priority based and/or weight based and/or opportunistic based.

The method may comprise using the receiver for D2D operation during a time T0 in which a SCell is deactivated.

Moreover, there is disclosed a network node for a wireless communication network, the network node being adapted to instruct a D2D enabled node to share a receiver between D2D operation and cellular operation. The network node may comprise an instruction module for such instructing.

Accordingly, the use of the receiver for D2D operation and/or cellular operation may be controlled from the node or network side, respectively, e.g. taking into account scheduling and/or resource planning for the D2D enabled node.

The network node may be adapted to determine the sharing to be performed by the D2D enabled node based on a condition. The condition may be priority based and/or weight based and/or opportunistic based.

It may be considered that the network node, and/or the instructing module, may be adapted to instruct the D2D enabled node to perform D2D operation with a first carrier and cellular operation with a second carrier.

Moreover, in some variants, the network node, and/or the instructing module, may be adapted to instruct the D2D enabled node to use the receiver for D2D operation during a time T0 in which a SCell is deactivated.

In addition, there is disclosed a method for operating a network node in a wireless communication network, the method comprising instructing a D2D enabled node to share a receiver between D2D operation and cellular operation.

The method may comprise determining the sharing to be performed by the D2D enabled node based on a condition. The condition may be priority based and/or weight based and/or opportunistic based.

It may be considered that the method comprises instructing the D2D enabled node to perform D2D operation with a first carrier and cellular operation with a second carrier.

In some variants, the method may comprise instructing the D2D enabled node to use the receiver for D2D operation during a time T0 in which a SCell is deactivated.

There is also disclosed a computer program product comprising instructions executable by control circuitry, the instructions causing the control circuitry to carry out and/or control one of the methods, in particular any one of the methods, disclosed herein when executed by the control circuitry.

Furthermore, a storage medium storing instructions executable by control circuitry is disclosed, the instructions causing the control circuitry to carry out and/or control one of the methods disclosed herein when executed by the control circuitry.

There may be considered an approach in which:
For communication, a D2D enabled node or UE is able to receive simultaneously in DL (cellular operation) and UL (D2D operation) of FDD carriers supporting D2D;
For discovery, the D2D enabled node or UE may not be able to receive simultaneously in the DL and UL of FDD carriers supporting D2D.

A D2D enabled node or UE capable of receiving in more than one carrier frequencies, but operating D2D in one of the carrier frequencies, may become restricted in at least one of: its cellular operation over the remaining carrier frequencies, in the carrier frequency shared with D2D, and its D2D operation.

The carrier aggregation performance may be degraded due to missed subframes on which the D2D enabled node or UE is scheduled (e.g. for transmission or in particular reception in D2D) or performing measurements. The network node (e.g. allocation node or coordinating node) may remain oblivious of the data blocks missed by the D2D enabled node or UE due to the scheduling or measurements or D2D reception.

Therefore such packets/data blocks may not be retransmitted by the network until the misses are detected by higher layer protocols e.g. radio link control (RLC), IP, etc. This may significantly increase the packet transmission delay and can be particular problem for real-time services.

The randomly missed packets also degrade the link adaptation of the cellular DL scheduling channel e.g. PDCCH in LTE. To compensate data or packets missed on PDCCH, the network may increase the resources for PDDCH (e.g. control channel element and/or transmit power). This in turn will consume more resources for PDCCH and will in turn reduce cellular DL capacity and/or increase interference on those resource elements.

There are described methods of operating over two or more carrier frequencies, when cellular and D2D receiver operations are sharing at least one D2D enabled node or UE receiver. Some of the sharing examples may prioritize one of the operation types and/or performing time-sharing. More specifically, the prioritization, weight-based and opportunistic receiver sharing approaches are described. The embodiments cover methods that can be implemented in a D2D enabled node or UE as well as in a network node, in particular allocation node or coordinating node.

There is described a method, which may be a method in or performed by a D2D enabled node, which may be adapted to have multi-carrier and/or CA functionality, or a multi-carrier UE, which is configured to receive signals on at least two different carrier frequencies, in particular D2D signals and/or cellular DL signals, the method comprising:

Obtaining information about at least one criterion or principle (e.g., priority-based, weight-based, opportunistic based) to be used by the D2D enabled node or UE for deciding whether to use at least one receiver resource for a first operation or for a second operation in a certain time-frequency resource, wherein the first operation is used for receiving D2D signals on a first carrier frequency and the second operation is used for receiving cellular DL signals on a second carrier frequency;

Determining the type of operation based on the obtained criteria;

Sharing or using at least one receiver resource for performing the determined operation over certain time-resource.

The method in a network node serving a UE, which is configured to receive D2D signals and cellular DL signals on at least two different carrier frequencies, the method comprising:

Obtaining information about at least one criterion or principle (e.g. priority-based, weight-based, opportunistic based) and/or signaling the said information to the UE, the said information is to be used by the D2D enabled node or UE for deciding whether to use at least one receiver resource for a first operation or for a second operation in a certain time-frequency resource, wherein the first operation is used for receiving D2D signal on a first carrier frequency and the second operation is used for receiving cellular DL signal on a second carrier frequency;

Determining the type of operation expected to be performed by the D2D enabled node or UE based on the obtained criteria;

Adapting scheduling of resources at the D2D enabled node or UE on DL cellular based on the expected operation being performed or to be performed by the UE.

Some scenarios are described herein:
Scenario 1: A D2D enabled node or UE is configured with two or more serving cells for DL multi-carrier cellular operation (i.e., CA in LTE) on f1 and f2 (f1 is different from f2) and also configured with D2D operation comprising at least receiving on f3 (f3 is different from f1 and f2).

Scenario 2: A D2D enabled node or UE is configured with two or more serving cells for DL multi-carrier cellular operation (i.e., CA in LTE) on f1 and f2 (f1 is different from f2) and also configured with D2D operation comprising at least receiving on f3 (f3 is the same as one of the f1 and f2).

In the scenarios above, the D2D enabled node or UE gets initiated or configured with or for the cellular operation before or after the D2D operation or with or for both of them at the same time. The configuration of either of the two or both may be internal in the UE, e.g., may be pre-configured, configured by another layer or by an application, triggered by a condition/an event/a timer, or configured by another node, e.g. a network node or coordinating node or allocation node.

In the above scenarios, a PCell may be configured on f1 and a SCell may be configured on f2. The SCell may be activated or deactivated. D2D receiving operation may be in the DL or

UL spectrum and may comprise receiving one or more radio signals and/or channels related to D2D operation directly (e.g., D2D signals or D2D channels or data) or indirectly (e.g., control or assistance data received via a D2D link or cellular link to support/configure D2D operation).

In the above, the D2D enabled node or UE is configured for both cellular and D2D receive operations, but may not be capable of simultaneously performing them on f1, f2 and f3, without any trade-off, e.g., due to a limited receiver or processing capability. Thus sharing mechanisms are necessary, which are described in more detail below. In particular, the receiver or receiver chain may not be adapted to receive on all of f1, f2 and f3 simultaneously and/or to receive cellular transmissions and D2D transmissions simultaneously.

The embodiments and scenarios herein are described for 2-carrier CA (on a cellular level) and D2D operation on one carrier frequency, but may be adapted also for a general case with configured N-carrier CA and K carrier frequencies for D2D (provided the D2D enabled node or UE supports simultaneous operation (in particular cellular and D2D) on less than N+K carriers and/or has at least one receiver less than N+K).

Some methods of sharing receiver resources of the D2D enabled node or UE in the scenarios described above are further described below in detail:
Priority-based sharing
Weight-based sharing
Opportunistic receiver resource sharing

The priority(-ies) and weight(s), as clarified later, may be pre-defined or configurable by the controlling network node, e.g. an allocation node or coordinating node. Based on the priority/weights, the D2D enabled node or UE may (re)configure one or more of its receivers. Additionally, the D2D enabled node or UE or the controlling network node may also select/configure/schedule the time-frequency resources for each corresponding operation type, accordingly.

In one embodiment, a sharing approach (priority-based sharing, weight-based sharing, or opportunistic sharing) may be used for some but not all CA configurations supported by the UE. In another embodiment, a sharing approach may be used when there is at least one deactivated SCell so that the corresponding receiver on that SCC may be ‘borrowed’ for D2D operation.

The network node may also decide which of the possible criteria or principles or mechanisms is to be used by the D2D enabled node or UE for sharing receiver resources between different operations (D2D or cellular DL receptions) for certain time period.

Therefore, the D2D enabled node or UE may also be configured by the network node with one or more of the three criteria to be used by the D2D enabled node or UE for determining the type of operation for sharing receiver resources.

The D2D enabled node or UE may be informed explicitly (e.g. by sending ID of the criteria to the UE) and/or implicitly by receiving one or more parameter(s) associated with a particular criterion or rule related to certain criterion e.g. priority of D2D operation over cellular DL, maximum time limit over which said priority is applicable etc. The D2D enabled node or UE may also use this information especially for invoking a pre-defined rule associated with a particular criterion, which is configured by the network node.

In one prioritization approach, one of the two operation types (D2D and cellular) may have assigned to it an absolute priority or a higher priority over the other one. In one non-limited example, the prioritization (e.g., of D2D over cellular or cellular over D2D) may be applied during up to a maximum limited time and/or over maximum N (e.g., N=1, 2, . . . ) number of carrier frequencies at a time. The maximum limited time and/or maximum N may be predetermined, e.g. stored in a memory of the UE, and/or determined and/or provided by the UE, e.g. based on operation conditions, and/or determined and/or provided by a network node, e.g. a coordinating or allocation node.

According to one embodiment, cellular DL multi-carrier operation may have an absolute priority or a higher priority over D2D receive operation or the whole D2D operation involving at least D2D receive operation. The D2D enabled node or UE may be adapted or instructed, in this case, to set the D2D receive operation and/or D2D operation or communication, in particular receiving utilizing the receiver, to be any one or more of
suspended,
delayed (e.g., for a certain time or until the prioritized operation is complete),
stopped (e.g., if started before the cellular operation is configured) or
dropped (e.g., dropped request for D2D operation).

In one example, the D2D operation may continue after the prioritized cellular operation is completed. In another example, the D2D operation may restart after the prioritized cellular operation is complete.

According to another embodiment, D2D receive operation or the whole D2D operation involving at least D2D receive operation may have an absolute priority or a higher priority over cellular DL multi-carrier operation. The D2D enabled node or UE may be adapted or instructed, in this case, to set the cellular DL multi-carrier operation or communication, in particular receiving utilizing a receiver, to be one or more of:
suspended,
delayed (e.g., for a certain time or until the prioritized operation is complete),
stopped (e.g., if started before the D2D operation is configured),
dropped (e.g., dropped request for cellular DL multi-carrier operation), or
transformed to another cellular operation type (e.g., to a single-carrier cellular operation or to a cellular operation involving a fewer receivers to enable using one of them for the prioritized D2D operation or more generally, when the D2D enabled node or UE supports N-carrier CA and K receivers are needed for D2D it may fall back to (N-k)-carrier operation where 1<=k<=K, which e.g. with k=K=1 becomes 2-carrier CA for N=3 or single-carrier for N=2).

In one example, the cellular DL multi-carrier operation may continue after the prioritized D2D operation is complete. In another example, the cellular DL multi-carrier operation may restart after the prioritized D2D operation is complete.

The priorities (of D2D or cellular or both) may be pre-defined or configurable (e.g., by another layer, application, or another node such as a network node which may be an eNodeB controlling the D2D enabled node or UE or ProSe server and/or an allocation node or coordinating node).

A priority may apply, e.g., for one or more of:
the whole (D2D or cellular) activity/operation or a specific activity/operation (e.g., D2D communication in general but not D2D discovery; cellular basic operations such as cell search or system information reading);
all carrier frequencies or only some carrier frequencies (e.g., D2D operation may get a higher priority only in the public safety frequency band or on a frequency used for public safety operation);
on the same carrier frequencies (e.g., a lower priority of cellular DL multi-carrier operation on f2 may imply that D2D receive operation gets a higher priority on the same f2 but not necessarily on f1 or on f3) or on different carrier frequencies (e.g., a lower priority of cellular DL multi-carrier operation may imply a higher priority of D2D operation on any of f1, f2 or f3);
any cell type or a specific cell type or cell configuration, e.g.,
cellular DL multi-carrier operation on SCell [but not necessarily on PCell] may have a lower priority than D2D operation, or
only deactivated SCell may have a lower priority for cellular DL multi-carrier operation than D2D operation;
operations for a certain purpose (e.g., public safety);
certain time of the day;
certain limited time interval (e.g., a higher priority may apply only for X ms);
certain load conditions (e.g., when the cellular load is above a threshold, a D2D operation may get a higher priority);
certain interference or received signal (strength or quality) conditions measured with respect to a threshold;
certain logical areas or geographical areas;
specific time-frequency resources (e.g., in subframes configured for D2D operation);
certain conditions with respect to network coverage (e.g., D2D may be prioritized at the cell edge);
receiving a specific signal/channel type.

The prioritization may result in receiver switching between cellular and D2D, e.g., at changing from one operation type to the other one when applying the priority, when restoring back, or when the priority applicability is time-limited or does not apply any more.

Typically, the prioritization approach may result in less frequent receiver switching than with weight-based sharing. However, the one-time impact of the receiver switching may be the same as with weight-based sharing approach (compare to details set out below which can apply in this section too).

According to one embodiment, prioritization is configured to reduce/minimize/avoid the impact of receiver switching between cellular and D2D receive operations. The switching between D2D rx (receiver functionality) and tx (transmitter functionality) may also be accounted for and reduced/minimized/avoided.

According to one embodiment, when a prioritization as described above is applied, the D2D enabled node or UE and network node have to ensure that the same requirements are met for the prioritized operation (e.g., D2D or cellular operation) in the scenarios with two types of operation as in the corresponding similar scenarios but with the prioritized operation type only.

For the second (non-prioritized) operation type, the requirements to meet shall be following the embodiments and behaviors described. For example, when the operation is to be restarted, also the measurement time is to be restarted or when the operation is delayed/postponed/paused&resumed or interrupted&continued, the measurement time shall be extended accordingly (e.g., as a function of the number of the interruptions and/or time of the interruptions).

In another example, if the CA configuration falls back to a configuration using fewer carriers, the requirements for or with the corresponding fewer-carrier configuration may apply (e.g., if 3-carrier CA falls back to 2-carrier CA, the requirements corresponding to the latter apply, or if 2-carrier CA falls back to a single-carrier operation, the requirements corresponding to the latter apply).
Some examples of requirements which may apply or be taken into account:
Cellular requirements (for PCell and/or activated SCell and/or deactivated SCell)
CA requirements
RRM measurement time and accuracy requirements
Measurement or feedback reporting requirements
System information reading time
BLER, BER, minimum number of reported ACK/NACKs
D2D requirements
Measurement time and accuracy requirements
Channel reading requirements
Measurement or feedback reporting requirements

The requirements above may be for the serving cell (PCell or SCell), intra-frequency, inter-frequency or inter-RAT requirements.

The requirements may also apply only for some but not all CA configurations supported by the UE.

According to this embodiment, the D2D enabled node or UE may be sharing, based on absolute or relative weights for the two type of operation, a receiver between cellular DL multi-carrier operation and D2D operation. The sharing may be in time, and the times during which the two operation types will operate may depend on the weights. During the times allocated for operation type 1, the operation may be similar to that described for the prioritized operation type with the prioritization approach (e.g., with the other operation type during that time postponed/delayed/suspended/paused&resumed/fell back to a fewer-carrier configuration, etc.); while during the times allocated for operation type 2 the operation of type 2 may be similar to that of the prioritized operation described for the prioritization case.

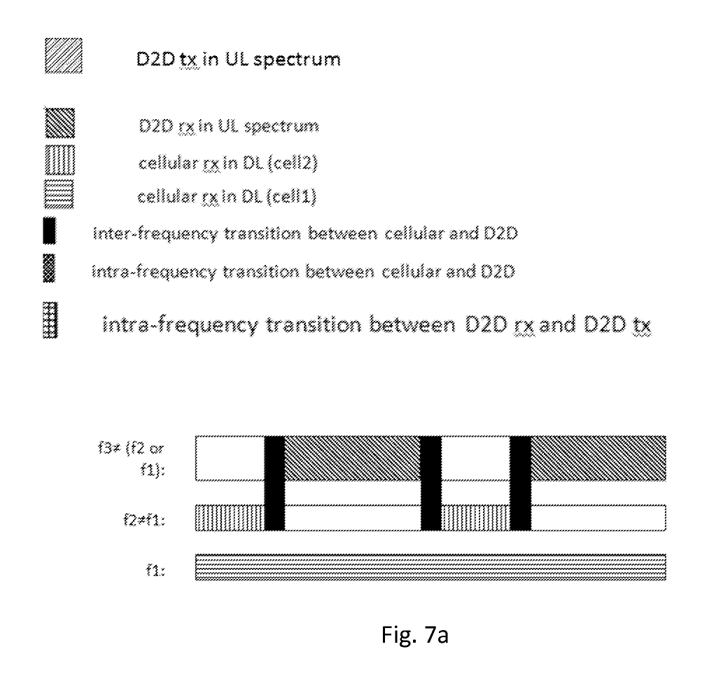

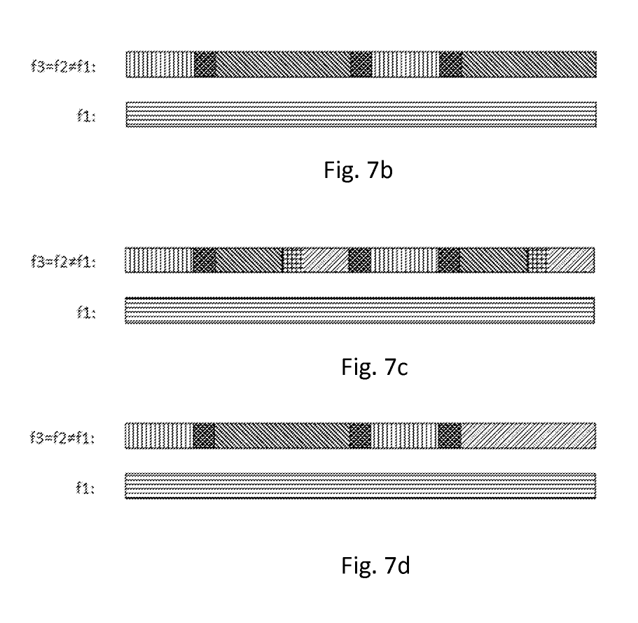

FIGS. 7a-7d illustrate different examples for weight-based sharing, where a PCell may be configured on f1 or f2 and a SCell may be configured on f2 or f1, correspondingly. One can observe that the sharing approach can result in inter-frequency or intra-frequency receiver switching between cellular and D2D, which may occur multiple times (e.g., periodically)—see also the remarks on receiver switching herein. A legend indicating the meaning of the different shadings used is included in FIG. 7a and pertains to FIGS. 7a to 7d. In the following, W_D2D indicates a weight parameter for D2D operation, W_cellular a weight parameter for cellular operation; in the examples, the ratio between such parameters may be of particular relevance (rather than the individual values themselves).

FIG. 7a shows inter-frequency switching, with, as an example,

W_D2D:W cellular=n:m=2:1.

FIG. 7b shows intra-frequency switching, with, as an example,

W_D2D:W_cellular=n:m=2:1, D2D tx is not used or used on a frequency different from D2D rx.

FIG. 7c shows intra-frequency switching, with, as an example,

W_D2D:W_cellular=n:m=1:1, D2D tx may be used on the same frequency as for D2D rx (there are resources available on f3).

FIG. 7d shows intra-frequency switching, with, as an example,

W_D2D:W_cellular=n:m=1:1, D2D tx may be used on the same frequency as for D2D rx (there are resources available on f3).

The weights may be pre-defined, derivable as a function of other parameters or explicitly configurable (e.g., by higher layers or an application or by another node such as a network node which may be an allocation node or coordinating node or eNodeB or D2D server), wherein the weight configuration may be static, semi-static or dynamic. For example, the weights may be described by means of weight factors W_D2D and W_cellular for D2D and cellular operations, respectively.

The weights may map to the corresponding portions of time and/or frequency in time during which the receiver is used for the corresponding operation type. For example, W_D2D:W_cellular=2:1 may mean that a UE's receiver is shared between D2D and cellular in a way that it is used for D2D twice as long as for cellular or twice as frequent as for cellular.

In another example, the weights may map to a probability of using/allocating the UE's receiver for an operation type. The weights may be applied to pre-defined timescales, e.g. slots and/or subframes.

The weight applicability may follow similar rules described for priority applicability outlined above.

As illustrated in FIGS. 7a-d, the sharing approach may result in multiple switchings between D2D and cellular operations, which may be inter-frequency or intra-frequency switching, wherein the intra-frequency switching may be on the PCell or SCell carrier frequency.

The intra-frequency receiver switching may be of two types:
Type 1: Between cellular DL and D2D UL, if the D2D rx is receiving in the UL spectrum (the current 3GPP assumption).
Type 2: Between cellular DL and D2D DL, if the D2D rx is receiving in the DL spectrum.

In one example, the inter-frequency switching times may be different from intra-frequency switching time, e.g., to accommodate and/or take into account the time required for frequency tuning of the receiver for the inter-frequency case. For the intra-frequency case, the receiver does not need to retune to another frequency. In one embodiment, the infra-frequency switching time may be zero, at least in some scenarios and under some conditions. In another embodiment, the intra-frequency switching time may be non-zero due to a different timing reference for UL than for DL.

The intra-frequency Type 1 and Type 2 switching times may also be different. In fact, in one example, the switching time for Type 2 switching may be zero, provided the rx timing of D2D is within the CP length.

According to one embodiment, the weight-based sharing is configured to reduce/minimize/avoid the impact of receiver switching between cellular and D2D receive operations. The switching between D2D rx and tx may also be accounted for and reduced/minimized/avoided. For example, it may be considered that:
The minimum time slot or interval assigned for continuous operation for an operation type shall not be shorter than X ms or M subframes.

The requirements applicability with the weight-based sharing approach may be similar to that with the priority-based approach (see above). However, with the weight-based approach, the first operation type is more likely to continue when the second operation type is over according to the time slot or interval allocation based on the corresponding weights. Additionally, the requirements with the weight-based sharing approach may also follow one or more of the following example rules:
The measurement time for operation type 1 may depend on the weight W1 associated with this operation type.
The measurement time for operation type 1 may depend on the weight W2 associated with the other operation type or on the relation between W1 and W2.
The measurement time for operation type 1 may depend on the time slot length continuously used for this operation (no interruption or switching may occur is the time slot is long enough to complete the measurement).
The measurement time for operation type 1 may depend on the periodicity of the time slot or interval allocation for this operation (if the periodicity is long, the measurement time may also be long, when a single time slot is not enough to complete the measurement).

The requirements may be different with inter-frequency and intra-frequency switchings. The requirements may be different with intra-frequency Type 1 and Type 2 switchings.

Alternatively or additionally, according to variant, based on the availability of resources not likely to be used simultaneously by both D2D and cellular DL multi-carrier, the D2D enabled node or UE may dynamically share a receiver between cellular DL multi-carrier operation and D2D operation.

The resource herein may mean any type of time, frequency or time-frequency resources e.g. subframes, resource blocks, subbands, etc. To share the receiver, the D2D enabled node or UE may be adapted to first determine the availability of such resources and based on this it may receive the DL cellular signals or D2D signals. Also, to facilitate receiver sharing between DL cellular and D2D operations, the network node (e.g. an allocation node or coordinating node) may also intentionally make such resources available. The D2D enabled node or UE may be adapted to inform the network node if it has shared the receiver for one of the D2D reception and cellular DL signal reception in any of the previous resources, e.g. subframes.

For example, the D2D enabled node or UE may indicate that it has missed signal reception in cellular DL subframes #3 and #4 in frame #10 (i.e. SFN=9) and instead used them for D2D signal reception. The network node may, based on such indication or information, determine to resend or reschedule cellular DL signals, which may have been sent during (time) resources used for D2D, e.g. during the missed subframes (i.e. subframes #3 and #4 in frame #10, which may be considered to be missed subframes in the context of cellular communication as they were not available for such communication). This embodiment is further elaborated with few examples:

a) The duration (T0) over which at least one of the SCell(s) is deactivated can be considered by the D2D enabled node or UE as the time during which the resources are available for D2D operation. The SCell is deactivated to save D2D enabled node or UE battery power e.g. when there is no data to send. Therefore the D2D enabled node or UE is not scheduled for cellular communication on a deactivated SCell, for example no DL cellular data reception and transmission are expected to take place. During T0, the D2D enabled node or UE may use the receiver (i.e. unused due to deactivated SCell) for D2D operation. The D2D enabled node or UE may receive an explicit command, e.g. by a network node (e.g. allocation node or coordinating node, which may be an eNB) to activate or deactivate SCell. Therefore, the D2D enabled node or UE is fully aware when a particular SCell is deactivated. The expected time over which SCell will remain deactivated (i.e. T0) may also be signaled by the network node to the UE. A certain minimum value of T0 (e.g. 100 ms) may additionally or alternatively be pre-defined and, e.g., be stored in the D2D enabled node or UE to be read. The D2D enabled node or UE may alternatively or additionally be adapted to predict or estimate or determine T0 based on amount of traffic in the buffer and/or type of service. For example, if there is no or low traffic, the D2D enabled node or UE may set T0 to be long, e.g. longer than the minimum value and/or longer than a value transmitted by the network node, e.g. 1 or 2 seconds. For an example, it may be assumed that T0=1000 ms and that the D2D enabled node or UE is expected to receive D2D signals of other D2D enabled nodes or UEs (e.g. discovery signals, beacon signals, etc.) once every 40 ms. This means the D2D enabled node or UE may expect to receive at least 25 instances of D2D signals without causing any interruption to DL cellular reception, e.g. without impact on reception of DL cellular signals in the PCell or on any other activated SCell. The D2D enabled node or UE may additionally or alternatively adapted to perform measurements on cells of SCC with the deactivated SCell, e.g. once every 320 ms.

In one example, the latter may be performed when the periodic measurement occasions do not collide with the D2D subframes and do not disturb them due to receiver switching event being sufficiently wide apart. In another example, for receiving D2D signals, the D2Denabled node or UE may additionally or alternatively take into account such instances when radio measurements are done on SCC with a deactivated SCell.

That is, the D2D enabled node or UE may be adapted to not receive D2D signals when such radio measurements are done, e.g. by correspondingly switching the receiver and/or suitable scheduling of receiver resources. To facilitate receiver sharing, the network node may also deliberately deactivate one of the SCells for certain time period. If the network node, e.g. an allocation node or coordinating node, is aware of the expected D2D operation, then the network node may deactivate at least one SCell during the occasions or time intervals or resources (e.g. subframes) over which the D2D enabled node or UE is expected to receive D2D signals. The network node may determine the occasions when D2D operation is expected based on pre-defined information (e.g. pattern or periodicity of D2D signal transmission such as beacon signals, synchronization signals, discovery signals, etc.)

and/or stored information and/or historical data (e.g. stored information regarding the previous behavior and/or scheduling) and/or a corresponding indication or message received from the D2D enabled node or UE and/or from another network node, which may e.g. indicate scheduled D2D transmissions.

b) Alternatively or additionally, a multi-carrier capable D2D enabled node or UE supporting at least one SCell may be configured by the network node to operate in an under-configuration or in a sub-configuration mode. In the sub-configuration mode, at least one of the SCells may be not configured and/or used. For example, a D2D enabled node or UE supporting 2 CCs may be configured in a single carrier mode, e.g. only with a PCell. In another example, a D2D enabled node or UE supporting 3 CCs may be configured in a CA mode with 2 CCs, e.g. only with a PCell and one SCell. A D2D enabled node or UE configured in sub-configuration may reuse its spare receiver for D2D operation as long as the D2D enabled node or UE remains in such mode. To facilitate receiver sharing, the network node may also deliberately deconfigure one of the SCell for a certain time period, such as over the duration when D2D operation is expected to take place. The network node may determine such occasions using the same principle as described in example #1 above.

c) Alternatively or additionally, the D2D enabled node or UE may be adapted to use CSI measurements (which are also generally reported to network node) of DL cellular signals for determining or scheduling available resources for D2D signal reception. Examples of CSI are CQI, rank indicator (RI), pre-coding matrix indicator (PMI) or any combination therefore etc. For example, if the CQI estimate by the D2D enabled node or UE for a certain SCell in one or more subframes (J) is below a certain threshold (e.g. CQI index is 5 or lower), then the D2D enabled node or UE may assume that it will not be scheduled on DL on that SCell in certain subframe(s). During such subframe(s), the D2D enabled node or UE can therefore reuse the receiver resources for D2D signal reception. The network node may also configure the D2D enabled node or UE with a threshold related to CSI (e.g. CQI index=4) and also type of CSI (e.g. CQI) to be considered for determining the SCell on which the D2D enabled node or UE may not be scheduled due to sub-quality CSI.

d) Alternatively or additionally, the D2D enabled node or UE may be adapted to use and/or take into account the signal quality of previously received D2D signals for determining or scheduling available resources for DL cellular reception. Examples of signal quality metrics are SINR, SNR, BLER, BER, detection probability, etc. For example, the D2D enabled node or UE may be adapted to not receive or schedule D2D reception in and/or for D2D signals in the next P number of D2D reception occasions, if a D2D received signal or signal quality (e.g. discovery signal quality, synchronization signal quality etc) received in the last at least L number of D2D reception occasions is below a threshold. The D2D enabled node or UE may instead be adapted to use and/or schedule these occasions for receiving DL cellular signals. After P occasions, the D2D enabled node or UE may attempt to receive D2D signals and/or determine the signal quality to decide whether to receive D2D signals in the subsequent P occasions or not. As a special case, L and P can be 1. A D2D reception occasion may correspond or associated to events in which D2D reception occurred or occurs and/or a time or time interval, in particular between (e.g. expected or scheduled) D2D transmission aimed at the D2D enabled node by another D2D enabled node.

e) Alternatively or additionally, the D2D enabled node or UE may be adapted to decide the use of receiver resources for D2D and/or DL cellular based on comparison between CSI and D2D signal qualities with respect to their threshold, for example in a combination of schemes of examples #3 and #4. For example:
If the CSI quality in previous J subframes is below a threshold, and the D2D received quality in previous L occasions is above a threshold, then D2D enabled node or UE may determine to use the next P occasions for D2D reception.
If the CSI quality in previous J subframes is above a threshold and the D2D received quality in previous L occasions is below a threshold, then the D2D enabled node or UE may determine to use the next R subframes for DL cellular reception.

In all other cases, the D2D enabled node or UE may determine to use the receiver for a particular purpose, which may be a default purpose or configured by the network node; e.g. the use of the receiver for only DL cellular reception.

Herein it may be considered that: J≧1; L≧1; R≧1 and P≧1. Generally, determining the use of the receiver may comprise scheduling and/or controlling the receiver correspondingly.

f) Alternatively or additionally, the network node may obtain information about the occasions during which the D2D operation is expected as described in example #1 (e.g. from UE, historical data, pre-defined information or another network node etc). The network node may then avoid scheduling the D2D enabled node or UE with DL cellular signals on at least one of the SCells during all or subset of such occasions. In this way, the D2D enabled node or UE can use the receiver resources for D2D signal reception during the subframes the D2D enabled node or UE is not scheduled for cellular communication.

g) Alternatively or additionally, the D2D enabled node or UE may be allowed to autonomously deactivate one of the SCells during the time instances (e.g. subframes) over which the D2D enabled node or UE is expected to receive D2D signals and share D2D resources for D2D reception. The D2D enabled node or UE may be allowed to autonomously deactivate the SCell only when permitted by the network node. The network node may also indicate the SCell which the D2D enabled node or UE is allowed to deactivate. The D2D enabled node or UE and network node may also communicate with each other to determine the time resources during which the D2D enabled node or UE is allowed to autonomously deactivate one of the SCells for the purpose of receiving D2D signals.

According to such an additional or alternative variant, the D2D enabled node or UE may be adapted to signal a capability to a network node indicating whether it is capable of sharing its radio receiver resources between D2D operation and cellular operation.

The D2D enabled node or UE may also indicate that it can share one or more radio receivers generally used for receiving signals on cells of SCC, for D2D operation when not used for cellular operation.

The D2D enabled node or UE capability information may also indicate which one or more of the criteria or principles (described above) can be used by the D2D enabled node or UE to determine or scheduling sharing of its receiver resources between D2D operation and cellular operation. The capability may also apply for certain carrier frequencies/frequency bands and/or their combinations.

The D2D enabled node or UE may be adapted to transmit or signal the capability information to the network node autonomously and/or based on explicit request received from the network node and/or triggered by an event or condition and/or together with other capabilities to join a cell and/or when indicating D2D-related capabilities to the network.

The network node may be adapted to use the received D2D enabled node or UE capability information transmitted or signaled, and received by the network node, for one or more of the following purposes:
To transmit the said capability information to another network node e.g. any of: eNB sends it to another eNB, eNB sends it to core network (CN) node (e.g. MME), CN node sends it to eNB etc.
To store the said capability information in a memory, for retrieving it at a future time for use.
To decide or determine, based on the said capability information, which of the criteria or principle for receiver sharing is to be employed for the UE.
To adapt cellular and/or D2D scheduling for the UE.
To adapts DL CA configuration for the UE.

There are provided more efficient and dynamic D2D enabled node or UE receiver capacity utilization in scenarios with cellular and D2D operation. Moreover, on average, the performance of cellular as well as D2D operation may be enhanced. The performance of D2D operation can in particular be enhanced for a high end multi-carrier capable D2D enabled node or UE supporting several SCCs (e.g. 2 or more), if all supported SCCs are not used all the time. The network may prioritize the performance of whichever of D2D and cellular is more critical at a given time.

A receiver or receiver chain may generally be provided by a transceiver arrangement, which may have transmitting capabilities included, or as a separate arrangement, which may be implemented without having transmitting capacities included.

A measurement gap may refer to a time gap or interval, in which no transmission and reception happens, in particular regarding a serving cell or a given carrier. Since there is no signal transmission and reception during the gap (at least in the serving cell or given carrier), a D2D enabled node or UE can switch to another or a target cell or carrier and/or perform a measurement on the target cell or carrier, e.g. for signal quality, utilizing the same receiver.

Generally, there is also disclosed a computer program product comprising instructions executable by control circuitry and/or a computing device, the instruction causing the control circuitry and/or computing device to carry out and/or control any one of the methods described herein when executed by the control circuitry and/or computing device. The control circuitry and/or computing device may be implemented in any one or more than one of the nodes to carry out and/or control corresponding methods or method steps.

Modules performing method steps described herein may generally be implemented in software and/or hardware and/or firmware in and/or on corresponding nodes. Modules of or on or in one node may be implemented in a common module or flow and/or in parallel and/or independent modules or flows.

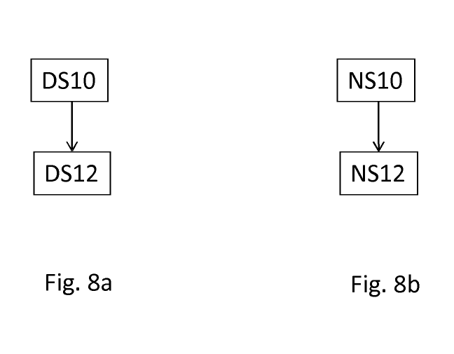

FIG. 8a shows a diagram of an exemplary method for operating a D2D enabled node, which may be a D2D enabled node as described herein. The method comprises an optional action DS10 of obtaining information regarding a condition and an action DS12 of sharing use of a receiver of the D2D enabled node between D2D operation and cellular operation based on the condition.

FIG. 8b shows a diagram of an exemplary method for operating a network node, which may be a network node as described herein. The method comprises an optional action NS10 of obtaining information about a condition and an action NS12 of instructing a D2D enabled node to share a receiver between D2D operation and cellular operation, e.g. based on the condition.

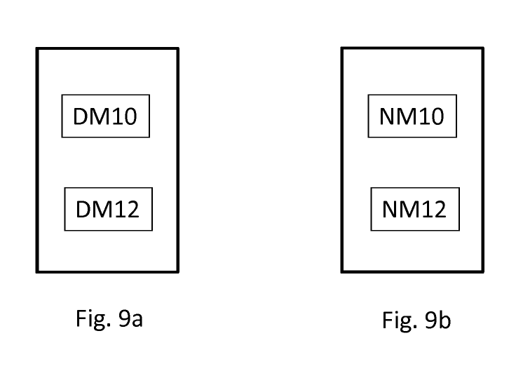

FIG. 9a shows an exemplary D2D enabled node, which may be a D2D enabled node 10. The D2D enabled node may comprise an optional obtaining module DM10 for performing action DS10. The D2D enabled node comprises a sharing module DM12 for performing action DS12.

FIG. 9b shows an exemplary network node, which may be a network node 100, e.g. a base station. The network node may comprise an optional obtaining module NM10 for performing action NS10. The network node comprises an instructing module NM12 for performing action NS12.

In the context of this description, wireless communication may be communication, in particular transmission and/or reception of data, via electromagnetic waves and/or an air interface, in particular radio waves, e.g. in a wireless communication network and/or utilizing a radio access technology (RAT). The communication may be between nodes of a wireless communication network and/or in a wireless communication network. It may be envisioned that a node in or for communication, and/or in, of or for a wireless communication network is adapted for, and/or for communication utilizing, one or more RATs, in particular LTE/E-UTRA. A communication may generally involve transmitting and/or receiving messages, in particular in the form of packet data. A message or packet may comprise control and/or configuration data and/or payload data and/or represent and/or comprise a batch of physical layer transmissions.

Control and/or configuration data may refer to data pertaining to the process of communication and/or nodes of the communication. It may, e.g., include address data referring to a node of the communication and/or data pertaining to the transmission mode and/or spectral configuration and/or frequency and/or coding and/or timing and/or bandwidth as data pertaining to the process of communication or transmission, e.g. in a header. Each node involved in communication may comprise radio circuitry and/or control circuitry and/or antenna circuitry, which may be arranged to utilize and/or implement one or more than one radio access technologies. Radio circuitry of a node may generally be adapted for the transmission and/or reception of radio waves, and in particular may comprise a corresponding transmitter and/or receiver and/or transceiver, which may be connected or connectable to antenna circuitry and/or control circuitry. Control circuitry of a node may comprise a controller and/or memory arranged to be accessible for the controller for read and/or write access.

The controller may be arranged to control the communication and/or the radio circuitry and/or provide additional services. Circuitry of a node, in particular control circuitry, e.g. a controller, may be programmed to provide the functionality described herein. A corresponding program code may be stored in an associated memory and/or storage medium and/or be hardwired and/or provided as firmware and/or software and/or in hardware. A controller may generally comprise a processor and/or microprocessor and/or microcontroller and/or FPGA (Field-Programmable Gate Array) device and/or ASIC (Application Specific Integrated Circuit) device. More specifically, it may be considered that control circuitry comprises and/or may be connected or connectable to memory, which may be adapted to be accessible for reading and/or writing by the controller and/or control circuitry. Radio access technology may generally comprise, e.g., Bluetooth and/or Wifi and/or WIMAX and/or cdma2000 and/or GERAN and/or UTRAN and/or in particular E-Utran and/or LTE.

A communication may in particular comprise a physical layer (PHY) transmission and/or reception, onto which logical channels and/or logical transmission and/or receptions may be imprinted or layered. A node of a wireless communication network may be implemented as a user equipment and/or base station and/or relay node and/or any device generally adapted for device-to-device communication. A wireless communication network may comprise at least one of a device configured for device-to-device communication and/or a user equipment and/or base station and/or relay node, in particular at least one user equipment, which may be arranged for device-to-device communication with a second node of the wireless communication network, in particular with a second user equipment. A node of or for a wireless communication network may generally be a wireless device configured for wireless device-to-device communication, in particular using the frequency spectrum of a cellular and/or wireless communications network, and/or frequency and/or time resources of such a network. Device-to-device communication may optionally include broadcast and/or multicast communication to a plurality of devices or nodes.

In some examples, the terms ‘D2D’ or ‘proximity service’ (ProSe) or ‘peer-to-peer communication’ may be used interchangeably.

A D2D UE or D2D device or D2D enabled node, which may interchangeably be called UE or D2D-capable UE or node, may comprise any entity or device or node capable of at least receiving or transmitting radio signals on a direct radio link, i.e., between this entity and another D2D capable entity. A D2D-capable device may also be comprised in or comprise a cellular UE, PDA, a wireless device, laptop, mobile, sensor, relay, D2D relay, or even a small base station employing a UE-like interface, etc. A D2D enabled node or UE is able to support at least one D2D operation.

A D2D operation may comprise any action or activity related to D2D, e.g., transmitting or receiving a signal/channel type for D2D purpose, transmitting or receiving data by means of D2D communication, transmitting or receiving control or assistance data for D2D purpose, transmitting or receiving a request for control or assistance data for D2D, selecting a D2D operation mode, initiating/starting D2D operation, switching to D2D operation mode from a cellular operation mode, configuring receiver or transmitter with one or more parameters for D2D. D2D operation may be for a commercial purpose or to support public safety, using the data related to D2D. D2D operation may or may not be specific to a certain D2D service. A D2D receive operation may be, and/or be comprised in, a D2D operation, which may, in one example, also involve other than D2D receive operations. A D2D operation may generally be performed or performable by a D2D enabled node or UE.

Cellular operation (in particular by UE) may comprise any action or activity related to a cellular network (any one or more RATs). Some examples of cellular operation may be a radio signal transmission, a radio signal reception, performing a radio measurement, performing a mobility operation or RRM related to a cellular network.

D2D transmission is any transmission by a D2D enable node or device and/or in a D2D operation or mode or communication. Some examples of D2D transmission may comprise physical signals or physical channels, dedicated or common/shared, e.g., reference signal, synchronization signal, discovery channel, control channel, data channel, broadcast channel, paging channel, scheduling assignment (SA) transmissions, etc. A D2D transmission on a direct radio link may be intended for receiving by another D2D device. A D2D transmission may be a unicast, groupcast, or broadcast transmission. A D2D transmission may be on the uplink time-frequency resources of a wireless communication system.

A coordinating node: a node or network node that schedules, decides, at least in part, or selects or allocates time-frequency resources to be used for at least one of: cellular transmissions and D2D transmissions. The coordinating node may also provide the scheduling information to another node such as another D2D device, a cluster head, a radio network node such as eNodeB, or a network node (e.g. a core network node). The coordinating node may communicate with a radio network node. It may be envisioned that a coordinating node is, and/or provides the functionality of, an allocation node.

Radio spectrum: Although at least some of the embodiments are described for D2D transmissions in the UL spectrum (FDD) or UL resources (TDD), the embodiments are not limited to the usage of UL radio resources, neither to licensed or unlicensed spectrum, or any specific spectrum at all.

A cellular network may comprise e.g. an LTE network (FDD or TDD), UTRA network, CDMA network, WiMAX, GSM network, any network employing any one or more radio access technologies (RATs) for cellular operation. The description herein is given for LTE, but it is not limited to the LTE RAT.

RAT (radio access technology) may generally include: e.g. LTE FDD, LTE TDD, GSM, CDMA, WCDMA, WiFi, WLAN, WiMAX, etc.

A network node may be a radio network node or another network node, which may be an allocation node or coordinating node. Some examples of the radio network node are a radio base station, a relay node, an access point, a cluster head, RNC, etc. The radio network node may be comprised in a wireless communication network and may also support cellular operation. Some examples of a network node, which is not a radio network node may comprise: a core network node, MME, a node controlling at least in part mobility of a wireless device, SON node, O&M node, positioning node, a server, an application server, a D2D server (which may be capable of some but not all D2D-related features), a node comprising a ProSe function, a ProSe server, an external node, or a node comprised in another network. A network node may be considered to be serving a D2D enabled node or UE, if it provides a cell of a cellular network to the served node or D2D enabled node or UE and/or is connected or connectable to the D2D enabled node or UE via and/or for transmission and/or reception and/or UL and/or DL data exchange or transmission.

Multiple carrier frequencies or functionality may refer to any of: different carrier frequencies within the same frequency band or within different frequency bands, same PLMN or different PLMNs, same RAT or different RATs. D2D operation may or may not occur on dedicated carrier frequencies. DL and UL carrier frequencies in FDD are also examples of different carrier frequencies. A frequency band herein may be FDD, TDD, HD-FDD, or even unidirectional (e.g., DL-only band such as Band 29, in some examples). Multiple carrier functionality may include carrier aggregation functionality.

A D2D enabled node may generally be a node adapted to perform D2D communication and/or at least one type of D2D operations, in particular a terminal and/or user equipment. The D2D enabled node may be adapted to transmit D2D data based on allocation data, in particular on and/or utilizing resources indicate in the allocation data. D2D communication and/or transmission by a D2D enabled node may generally be in UL resources and/or corresponding carrier or frequency and/or modulation. In this context, stopping D2D communication in response and/or based on a release message may be considered to correspond to transmitting based on allocation data, wherein the release message may be considered to be allocation data.

A user equipment (UE) may generally be a device configured for wireless device-to-device communication and/or a terminal for a wireless and/or cellular network, in particular a mobile terminal, for example a mobile phone, smart phone, tablet, PDA, etc. A user equipment may be a node of or for a wireless communication network as described herein, in particular a D2D enabled node. It may be envisioned that a user equipment is adapted for one or more RATs, in particular LTE/E-UTRA. A user equipment may generally be proximity services (ProSe) enabled. It may be considered that a user equipment comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A node or device of or for a wireless communication network, in particular a node or device for device-to-device communication, may generally be a user equipment. It may be considered that a user equipment is configured to be a user equipment adapted for LTE/E-UTRAN.

A base station may be any kind of base station of a wireless and/or cellular network adapted to serve one or more user equipments. It may be considered that a base station is a node of a wireless communication network. A base station may be adapted to provide and/or define one or more cells of the network and/or to allocate frequency and/or time resources for communication to one or more nodes of a network, in particular UL resources, for example for device-to-device communication, which may be communication between devices different from the base station. Generally, any node adapted to provide such functionality may be considered a base station. It may be considered that a base station comprises radio circuitry and/control circuitry for wireless communication. It may be envisioned that a base station is adapted for one or more RATs, in particular LTE/E-UTRA . Radio circuitry may comprise for example a receiver device and/or transmitter device and/or transceiver device.

Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A base station may be arranged to be a node of a wireless communication network, in particular configured for and/or to enable and/or to facilitate and/or to participate in device-to-device communication, e.g. as a device directly involved or as an auxiliary and/or coordinating node.

Generally, a base station may be arranged to communicate with a core network and/or to provide services and/or control to one or more user equipments and/or to relay and/or transport communications and/or data between one or more user equipments and a core network and/or another base station and/or be Proximity Service enabled. An eNodeB (eNB) may be envisioned as an example of a base station. A base station may generally be proximity service enabled and/or to provide corresponding services. It may be considered that a base station is configured as or connected or connectable to an Evolved Packet Core (EPC) and/or to provide and/or connect to corresponding functionality. The functionality and/or multiple different functions of a base station may be distributed over one or more different devices and/or physical locations and/or nodes. A base station may be considered to be a node of a wireless communication network. Generally, a base station may be considered to be configured to be a coordinating node and/or to allocate resources in particular for device-to-device communication between two nodes of a wireless communication network, in particular two user equipments.

Device-to-device (D2D) communication or operation may generally refer to communication between nodes of a wireless communication network or corresponding operation of one or more nodes, which may utilize the frequency spectrum and/or frequency and/or time resources of the network, in particular according to LTE/E-UTRAN. The communication may be wireless communication. A device in this context may be a node of the wireless communication network, in particular a user equipment or a base station. Device-to-device communication may in particular be communication involving at least one user equipment, e.g. between two or more user equipments. Device-to-device communication may be relayed and/or provided via a base station or coordinating node or relay node, in particular without interaction with a core network and/or layers of the network above a base station or coordinating node, or be direct communication between two devices, e.g. user equipments, without involvement of a base station or coordinating node and/or with a base station or coordinating node providing merely auxiliary services, e.g. configuration data or a transmission configuration or related information for a message intended for device-to-device communication between user equipments. In the latter case, it may be considered that data and/or signals flowing between the nodes performing device-to-device communication are not transported via the base station and/or coordinating node.

In contrast, during cellular communication, network layers above the eNB/base station/coordination node may generally be involved, in particular core layers which may be connected to the eNB/base station/coordinating node via cable/land line. During device-to-device communication, a message may be provided and/or transmitted and/or received. A message may be considered to be or be represented by a batch of physical layer transmissions and/or may comprise such. A message may comprise information regarding the transmission configuration, in particular regarding related information, e.g. in a header, and/or a payload. A unidirectional message may be a message for connectionless communication and/or for which no prior communication and/or prior connection between the transmitting node and receiving node is necessary and/or available and/or for which no response or no response protocol or no handshake is expected. A device configured for and/or capable of device-to-device communication, which may be called D2D enabled device or node, may comprise control circuitry and/or radio circuitry configured to provide device-to-device communication, in particular configured to enable proximity services (ProSe-enabled), e.g., according to LTE/E-UTRA requirements. D2D operation or communication and cellular operation or communication may be considered different operation types or modes, which may generally performed using resources from the same pool of available resources, e.g. allocated resources and/or the same carriers.

A storage medium may be adapted to store data and/or store instructions executable by control circuitry and/or a computing device, the instructions causing the control circuitry and/or computing device to carry out and/or control any one of the methods described herein when executed by the control circuitry and/or computing device. A storage medium may generally be computer-readable, e.g. an optical disc and/or magnetic memory and/or a volatile or non-volatile memory and/or flash memory and/or RAM and/or ROM and/or EPROM and/or EEPROM and/or buffer memory and/or cache memory and/or a database.

Allocated resources may generally be frequency and/or time resources. Allocated resources may comprise frequency-related information, in particular regarding one or more carriers and/or bandwidth and/or subcarriers and/or time-related information, in particular regarding frames and/or slots and/or subframes, and/or regarding resource blocks and/or time/frequency hopping information. Allocated resources may in particular refer to UL resources, e.g. UL resources for a first D2D enabled node to transmit to and/or for a second D2D enabled node. Transmitting on allocated resources and/or utilizing allocated resources may comprise transmitting data on the resources allocated, e.g. on the frequency and/or subcarrier and/or carrier and/or timeslots or subframes indicated. It may generally be considered that allocated resources may be released and/or de-allocated. A network or a node of a network, e.g. an allocation node, may be adapted to determine and/or transmit corresponding allocation data indicating release or de-allocation of resources to one or more D2D enabled nodes, in particular to a first D2D enabled node. Accordingly, D2D resource allocation may be performed by the network and/or by a node, in particular a node within and/or within a cell of a cellular network covering the D2D enabled nodes participating or intending to participate in the D2D communication.

The term “intra-frequency” may refer to issued related to the same frequency/bandwith and/or carrier, e.g. between neighboring cells (which may be provided by different BSs) having the same frequencies available. The term “inter-frequency” may refer to issues related to different frequencies/bandwidths and/or carriers, e.g. between different carriers in a multi-carrier arrangement.

A receiving operation may comprise a measurement operation, e.g. a signal quality measurement, which may be performed in a measurement gap, in which a receiver switching to a carrier/frequency to be measured may be performed.

Receiver switching may generally refer to switch a receiver between D2D operation and cellular operation (or vice versa) and/or to switch between different carriers or frequencies.

Receiver sharing may generally described providing a receiver or receiver resource for a different type of operation (D2D or cellular) at least part of the time and/or to use it for different types of operation (D2D or cellular) within a given time interval, e.g. a subframe or frame. Receiver sharing may be arranged or performed by switching the receiver between different operation types or modes, in particular within the given time interval.

### ABBREVIATIONS

3GPP 3^{rd} Generation Partnership Project
Ack/Nack Acknowledgment/Non-Acknowledgement, also A/N
AP Access point
BER/BLER Bit Error Rate, BLock Error Rate;
BS Base Station
CoMP Coordinated Multiple Point Transmission and Reception
CQI Channel Quality Information
CRS Cell-specific Reference Signal
CSI Channel State Information
D2D Device-to-device
DL Downlink
EPDCCH Enhanced Physical DL Control CHannel
DL Downlink; generally referring to transmission of data to a node/into a direction further away from network core (physically and/or logically); in particular from a base station or eNodeB to a UE; often uses specified spectrum/bandwidth different from UL (e.g. LTE)
eNB evolved NodeB; a form of base station, also called eNodeB
E-UTRA/N Evolved UMTS Terrestrial Radio Access/Network, an example of a RAT f1, f2, f3, . . . , fn carriers/carrier frequencies; different numbers may indicate that the referenced carriers/frequencies are different
FDD Frequency Division Duplexing
ID Identity
L1 Layer 1
L2 Layer 2
LTE Long Term Evolution, a telecommunications standard
MAC Medium Access Control
MBSFN Multiple Broadcast Single Frequency Network
NW Network
OFDM Orthogonal Frequency Division Multiplexing
O&M Operational and Maintenance
OSS Operational Support Systems
PDCCH Physical DL Control CHannel
PH Power Headroom
PHR Power Headroom Report
PSS Primary Synchronization Signal
RAT Radio Access Technology
RE Resource Element
RB Resource Block
RRH Remote radio head
RRM Radio Resource Management
RRU Remote radio unit
RSRQ Reference signal received quality
RSRP Reference signal received power
RSSI Received signal strength indicator
RX reception/receiver, reception-related
SA Scheduling Assignment
SINR/SNR Signal-to-Noise-and-Interference Ratio; Signal-to-Noise Ratio
SFN Single Frequency Network
SON Self Organizing Network
SSS Secondary Synchronization Signal
TX transmission/transmitter, transmission-related
TDD Time Division Duplexing
UE User Equipment
UL Uplink; generally referring to transmission of data to a node/into a direction closer to a network core (physically and/or logically); in particular from a D2D enabled node or UE to a base station or eNodeB; in the context of D2D, it may refer to the spectrum/bandwidth utilized for transmitting in D2D, which may be the same used for UL communication to a eNB in cellular communication; in some D2D variants, transmission by all devices involved in D2D communication may in some variants generally be in UL spectrum/bandwidth/carrier/frequency

These and other abbreviations may be used according to LTE standard definitions.

There is described a D2D enabled node, in particular for and/or of a wireless communication network. The D2D enabled node may comprise at least on receiver. It may be considered that the D2D enabled node is adapted to share, according to a condition, use of the receiver between D2D operation and cellular operation. The condition may be priority based and/or weight based and/or opportunistic based, in particular according to any one of the specifics above. The D2D enabled node may be adapted to determine sharing based on the condition. It may be considered that the D2D enabled node is adapted to obtain information regarding the condition, to perform the determination. Obtaining may be performed e.g. by measuring pertinent parameters and/or estimating or calculating and/or receiving information regarding the condition from another node, in particular a network node and/or allocation node and/or coordinating node and/or base station like an eNodeB. The D2D enabled node may be adapted to control the at least one receiver such that D2D operation is performed with a first carrier and cellular operation is performed with a second carrier. The first carrier may be different from the second carrier. Generally, D2D operation may comprise receiving D2D data and/or signals from a second D2D enabled node. Cellular operation may comprise receiving cellular data and/or signals in a cellular setup and/or from a network and/or a network node, in particular from a base station and/or eNodeB; cellular data and/or signals may be relayed, e.g. via a relay node.

There may generally be considered a D2D enabled node adapted to carry out any one of the methods described herein in the context of such a node. The D2D enabled node may be a D2D enabled node with a receiver as described herein.

There may be considered a network node, in particular an allocation node and/or coordinating node and/or base station and/or eNodeB, which may be a node for and/or in a wireless communication network; the network node may be adapted to carry out any one of the methods described herein in the context of such a node. The network node may be adapted to obtain and/or determine information about a condition (which may be a condition as outlined above regarding the D2D enabled node) and/or to provide or transmit such information to a D2D enabled node and/or to instruct the D2D enabled node to share a receiver between a first carrier and a second carrier and/or D2D operation and cellular operation. The network node may be adapted for carrier aggregated communication with the D2D enabled node in cellular operation, e.g. on its own and/or in conjunction with other network nodes. The network node may be adapted to determine the sharing to be performed by the D2D enabled node and/or the type of operation to be performed and/or the scheduling of types of operation for the D2D enabled node based on the condition. It may be considered that the network node is adapted to schedule resources, in particular DL resources, for the D2D enabled node based on this determination.

There is disclosed a method for operating a D2D enabled node in a wireless communication network, comprising at least one receiver. It may be considered that the D2D enabled node shares, according to a condition, use of the receiver between D2D operation and cellular operation. The condition may be priority based and/or weight based and/or opportunistic based, in particular according to any one of the specifics above. The D2D enabled node may determine sharing based on the condition. It may be considered that the D2D enabled obtains information regarding the condition, to perform the determination. Obtaining may be performed e.g. by measuring pertinent parameters and/or estimating or calculating and/or receiving information regarding the condition from another node, in particular a network node and/or allocation node and/or coordinating node and/or base station like an eNodeB. The D2D enabled node may control the at least one receiver such that D2D operation is performed with a first carrier and cellular operation is performed with a second carrier. The first carrier may be different from the second carrier. Generally, D2D operation may comprise receiving D2D data and/or signals from a second D2D enabled node. Cellular operation may comprise receiving cellular data and/or signals in a cellular setup and/or from a network and/or a network node, in particular from a base station and/or eNodeB; cellular data and/or signals may be relayed, e.g. via a relay node. The method generally may comprise carrying out any one of the methods described herein in the context of such a node. The D2D enabled node may be a D2D enabled node with a receiver as described herein.

There may be considered a method of operating a network node, in particular an allocation node and/or coordinating node and/or base station and/or eNodeB, in a wireless communication network; the network node may be adapted to carry out any one of the methods described herein in the context of such a node. The network node may obtain and/or determine information about a condition (which may be a condition as outlined above regarding the D2D enabled node) and/or provide or transmit such information to a D2D enabled node and/or instruct the D2D enabled node to share a receiver between a first carrier and a second carrier and/or D2D operation and cellular operation. The network node may be adapted for carrier aggregated communication with the D2D enabled node in cellular operation, e.g. on its own and/or in conjunction with other network nodes. The network node may be determine the sharing to be performed by the D2D enabled node and/or the type of operation to be performed and/or the scheduling of types of operation for the D2D enabled node based on the condition. It may be considered that the network node is adapted to schedule resources, in particular DL resources, for the D2D enabled node based on this determination.

Sharing of a receiver generally may comprise sharing the receiver in time, such that at different times/resources the receiver may be used for different types of operation and/or different carriers, wherein the carriers and types of operation may be as outlined above. A situation for sharing may arise in particular for cases in which the number of receivers available for use is lower than the carriers available for D2D and CA operation.

1-20. (canceled)

21. Device-to-device (D2D) enabled node for a wireless communication network, the D2D enabled node comprising:
a receiver; and
a control circuit configured to share, according to a condition, use of the receiver between D2D operation and cellular operation.

22. The D2D enabled node according to claim 1, the control circuit is configured to control the receiver such that D2D operation is performed with a first carrier and cellular operation is performed with a second carrier.

23. The D2D enabled node according to claim 21, wherein the condition is priority based, weight based and/or opportunistic based.

24. The D2D enabled node according to claim 20, wherein the control circuit is configured to use the receiver for D2D operation during a time T0 in which a SCell is deactivated.

25. A method for operating a device-to-device (D2D) enabled node in a wireless communication network, the D2D enabled node comprising a receiver, the method comprising:
sharing, according to a condition, use of the receiver between D2D operation and cellular operation.

26. The method according to claim 25, further comprising controlling the receiver such that D2D operation is performed with a first carrier and cellular operation is performed with a second carrier.

27. The method according to claim 25, wherein the condition is priority based, weight based and/or opportunistic based.

28. The method according to claim 25, further comprising using the receiver for D2D operation during a time T0 in which a SCell is deactivated.

29. A network node in a wireless communication network, the network node comprising:
a control circuit configured to instruct a device-to-device (D2D) enabled node to share a receiver between D2D operation and cellular operation.

30. The network node according to claim 29, the control circuit configured to determine the sharing to be performed by the D2D enabled node based on a condition.

31. The network node according to claim 29, wherein the condition is priority based, weight based and/or opportunistic based.

32. The network node according to claim 29, the control circuit configured to instruct the D2D enabled node to perform D2D operation with a first carrier and cellular operation with a second carrier.

33. The network node according to claim 29, the control circuit configured to instruct the D2D enabled node to use the receiver for D2D operation during a time T0 in which a SCell is deactivated.

34. The network node according to claim 29, wherein the network node is a base station or a user equipment configured for D2D communication.

35. A method for operating a network node in a wireless communication network, the method comprising:
instructing a device-to-device (D2D) enabled node to share a receiver between D2D operation and cellular operation.

36. A method according to claim 35, comprising determining the sharing to be performed by the D2D enabled node based on a condition.

37. A method according to claim 35, wherein the condition is priority based, weight based and/or opportunistic based.

38. A method according to claim 35, comprising instructing the D2D enabled node to perform D2D operation with a first carrier and cellular operation with a second carrier.

39. A method according to claim 35, comprising instructing the D2D enabled node to use the receiver for D2D operation during a time T0 in which a SCell is deactivated.

40. A computer program product for operating a device-to-device (D2D) enabled node in a wireless communication network, the D2D enabled node comprising a receiver, the computer program product stored on a non-transitory, computer readable medium and comprising program instructions, which when executed by at least one processor, causes the at least one processor to:
share, according to a condition, use of the receiver between D2D operation and cellular operation.

41. A computer program product for operating a network node in a wireless communication network, the computer program product stored on a non-transitory, computer readable medium and comprising program instructions, which when executed by at least one processor, causes the at least one processor to:
instruct a device-to-device (D2D) enabled node to share a receiver between D2D operation and cellular operation.
